(19) United States
(12) Patent Application Publication
(10) Pub. No.: US 2006/0197747 A1
(43) Pub. Date: Sep. 7, 2006

(54) Photosensing device

(75) Inventor: Chun-Hsiang Huang, Taipei (TW)

Correspondence Address: BRUCE H. TROXELL, SUITE 1404, 5205 LEESBURG PIKE, FALLS CHURCH, VA, 22041, US

(73) Assignee: Primax Electronics Ltd.

(21) Appl. No.: 11/117,355

(22) Filed: Apr. 29, 2005

(30) Foreign Application Priority Data
Mar. 2, 2005 (TW) 094106218

(51) Int. Cl. G09G 5/08

(52) U.S. Cl. 345/166

(57) ABSTRACT

A photosensing device for sensing an image of a working plane is provided. The photosensing device includes a light source, an image sensor, a lens and a spectroscope. The light source emits light to be projected onto the working plane. The image sensor is used for generating an electronic signal of an image of the working plane. The lens is used for focusing the light reflected from the working plane, and the lens and the image sensor have a common central axis. The spectroscope deflects at least a portion of the light emitted from the light source toward the working plane and allows the deflected light to be reflected toward the direction of the central axis so as to be received by the lens.

### FIELD OF THE INVENTION

The present invention relates to a photosensing device, and more particularly to a photosensing device for use with a pointing signal generation device.

### BACKGROUND OF THE INVENTION

A pointing signal generation device such as a mouse is an indispensable peripheral device of a computer system. The pointing signal generation device allows the user to control the movement of a cursor on a screen of the computer system.

When a conventional mouse is operated, a working plane such as a desk plane is required for the mouse to move thereon such that the cursor moves in the corresponding movement direction of the mouse.

Many pointing signal generation devices are employed to generate pointing signals. For example, the common pointing signal generation device is an optical-mechanical mouse, which is operated by using a trackball to drive a grating wheel. Recently, optical mice are growing popular.

The trackball mouse is disadvantageous in that the surface of the trackball is easily gummed up with dust and debris due to the contact with the desk plane. After an extended use, the precision and reliability of the trackball mouse is reduced and erroneous pointing signals may be generated because the grating wheel fails to be accurately rotated.

For a purpose of overcoming the drawback of the trackball mouse, an optical mouse was developed. The optical mouse generates pointing signals by using a lens assembly and an image signal sensor to sense the image of the desk plane.

Referring to FIG. 1, the optical assembly of a conventional optical mouse is shown. The optical mouse of FIG. 1 comprises a light source 1 such as a light emitting diode, an image capture lens 2 and a photosensor 3. This optical assembly is used to read the image from the desk plane T. The light A emitted from the light source 1 is projected onto the desk plane T in a direction tilted to the desk plane T. The light reflected from the desk plane T is focused by the image capture lens 2, and the focused light is received by the photosensor 3, thereby generating an image signal. Since the light A from the light source 1 is projected onto the desk plane T with a tilt angle, a portion of reflected light B is deviated and fails to be received by the image capture lens 2. In other words, only a portion of reflected light C passes through the image capture lens 2.

This conventional optical mouse is not applicable to the planes made of certain materials because no signals are sensed from these materials. For example, in a case that a transparent desk plane is provided, the optical mouse fails to function well. Please refer to FIG. 2, which illustrates the optical assembly of FIG. 1 used in a transparent desk plane T′. The transparent desk plane T′ comprises a first part T1′ and a second part T2′. The second part T2′ and the area between T1′ and T2′ are transparent and light transmissible. The texture of the desk plane T′ can be viewed from the first part T1′. The light A emitted from the light source 1 penetrates through the second part T2′ and is projected onto the first part T1′ of the desk plane T′ at a tilt angle. Since the displacement of the light A is varied in comparison with that of FIG. 1, the reflected light C′ from the first part T1′ of the desk plane T is less than the reflected light C in FIG. 1. Under this circumstance, only less amount of reflected light C′ passes through the image capture lens 2, and thus insufficient image is received by the photosensor 3. That is why the optical mouse is not applicable to a transparent desk plane.

In contrast, if the desk plane T as shown in FIG. 1 is a high reflective plane, for example a mirror plane, the reflective angle of the reflected light becomes large. In other words, the fraction of the reflected light B is increased, but the fraction of the reflected light C is reduced. Since insufficient amount of reflected light C is received by the photosensor 3, the pointing signals fail to be generated.

### SUMMARY OF THE INVENTION

It is an object of the present invention to provide a photosensing device capable of accurately sensing the working planes made of various materials so as generate accurate pointing signals.

In accordance with an aspect of the present invention, there is provided a photosensing device for sensing an image of a working plane. The photosensing device comprises a light source, an image sensor, a lens and a spectroscope. The light source emits light to be projected onto the working plane. The image sensor is used for generating an electronic signal of an image of the working plane. The lens is used for focusing the light reflected from the working plane, and the lens and the image sensor have a common central axis. The spectroscope deflects at least a portion of the light emitted from the light source toward the working plane and allows the deflected light to be reflected toward the direction of the central axis so as to be received by the lens.

In an embodiment, the further comprises a prism for deflecting the light emitted from the light source toward the working plane by approximately 90 degrees so as to be received by the spectroscope.

In an embodiment, the prism comprises a first transmissible surface, a reflective surface and a second transmissible surface. The light emitted from the light source penetrates through the first transmissible surface to the reflective surface and is reflected by the reflective surface so as to be deflected by the approximately 90 degrees, and the deflected light penetrates through the second transmissible surface.

In accordance with another aspect of the present invention, there is provided a pointing signal generation device which uses the photosensing device of the present invention.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the optical path of a photosensing device of a conventional optical mouse used with a first desk plane;

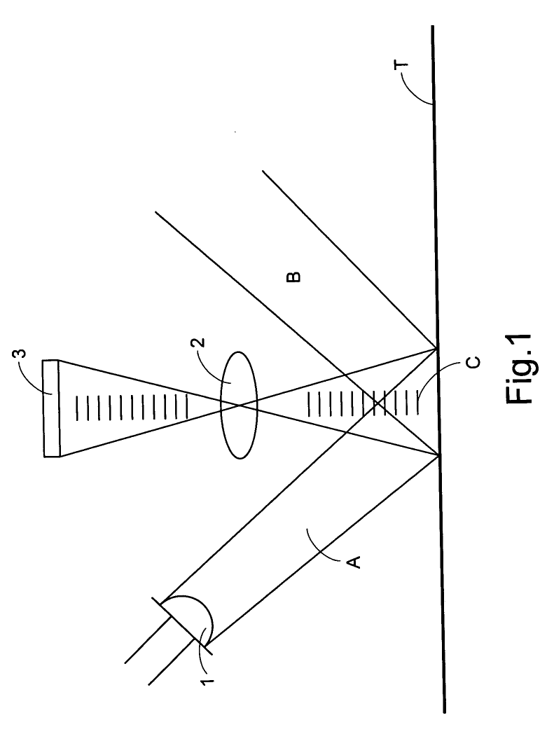

FIG. 2 is a schematic view illustrating the optical path of a photosensing device of a conventional optical mouse used with a second desk plane;

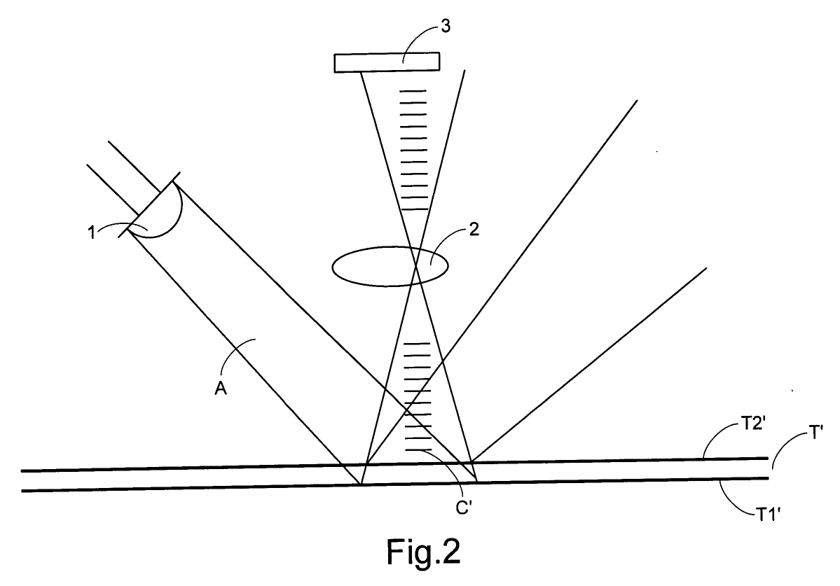

FIG. 3 is a schematic view illustrating the optical path of a photosensing device of an optical mouse used with a first desk plane according to a preferred embodiment of the present invention; and

FIG. 4 is a schematic view illustrating the optical path of a photosensing device of an optical mouse used with a second desk plane according to another preferred embodiment of the present invention.

### DETAILED DESCRIPTION OF THE PREFERRED EMBODIMENT

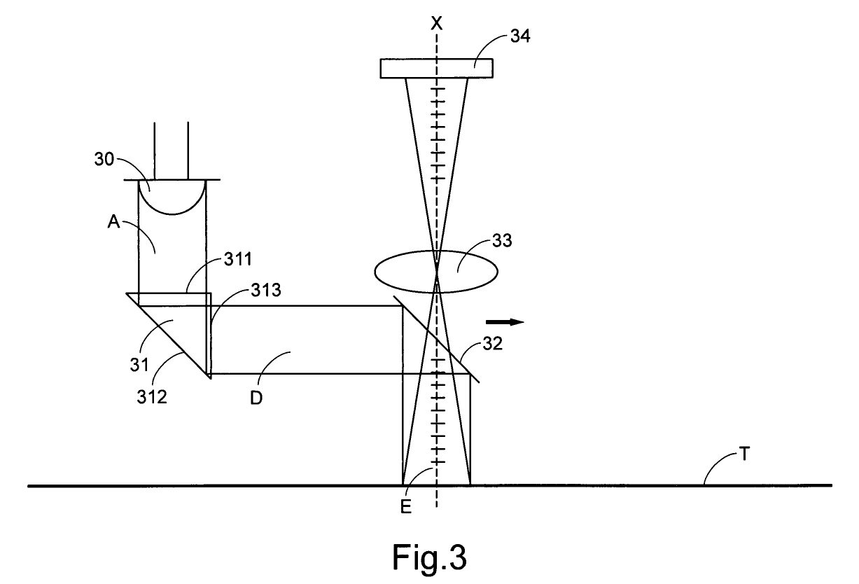

Referring to FIG. 3, a schematic view of a photosensing device according to a preferred embodiment of the present invention is shown. The photosensing device comprises a light source 30, a prism 31, a spectroscope 32, a lens 33 and an image sensor 34, which cooperatively work to sense the image signals from the desk plane T. The lens 33 and the image sensor 34 have a common central axis. The light source 30 emits light A in the direction normal to the desk plane, i.e. in a first direction. The light A penetrates through the first transmissible surface 311 of the prism 31 to the reflective surface 312 and is reflected by the reflective surface 312 so as to be deflected by approximately 90 degrees, and the deflected light penetrates through the second transmissible surface 313. Meanwhile, a horizontal light beam D, which is substantially parallel to desk plane T, is exited from the prism 31. By means of the spectroscope 32, a portion of the light beam D is deflected by 90 degrees and the deflected light beam E is vertically projected onto the desk plane T. The rest of the light beam D penetrates through the spectroscope 32. The light beam E, which is perpendicular to the desk plane T, is vertically reflected to the lens 33 and received by the image sensor 34.

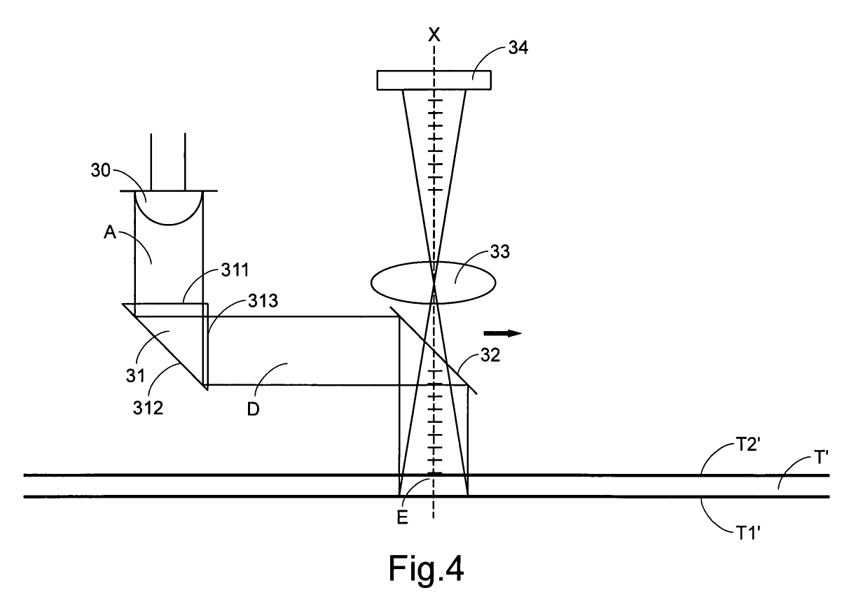

Since the light reflected from the spectroscope 32 is in the direction of the central axis X, the lens 33 and the image sensor 34 receive the maximum light quantity under this circumstance. Furthermore, the direction of the light reflected from the desk plane is the same as the common central axis X of the lens 33 and the image sensor 34. Thus, even if the photosensing device is used with a different desk plane having different texture, the lens 33 and the image sensor 34 can also receive the light along the central axis. A further embodiment of the photosensing device is illustrated in FIG. 4. As can been seen in FIG. 4, even if the photosensing device is used with the transparent desk plane T′, the lens 33 also receives the light along the central axis so as to avoid deviation of the light beam.

By the way, the prism 31 is optionally provided to adjust the position of the light source 30. In a case that the prism 31 is excluded from the photosensing device, the light emitted from the light source 30 is parallel to the desk plane T and directly projected onto the spectroscope 32.

From the above description, since the light reflected from the desk plane is coaxial with the lens and the image sensor by using the spectroscope 32, the reflected angle of the light reflected from the desk plane is substantially unchanged in a case that the photosensing device of the present invention is used with the different desk plane with different texture. The optical mouse of the photosensing device according to the present invention can accurately generate pointing signals when used with various desk planes. In addition, since the light reflected from the desk plane is coaxial with the lens and the image sensor, the light quantity received by the lens and the image sensor is not considerably distinguished when the texture of the desk plane is varied. Therefore, the present invention can use lower power light source such as a light emitting diode when compared with the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A photosensing device for sensing an image of a working plane, said photosensing device comprising:
a light source for emitting light to be projected onto said working plane;
an image sensor for generating an electronic signal of an image of said working plane;
a lens for focusing the light reflected from said working plane, said lens and said image sensor having a common central axis; and
a spectroscope for deflecting at least a portion of the light emitted from said light source toward said working plane and allowing the deflected light to be reflected toward the direction of said central axis so as to be received by said lens.

2. The photosensing device according to claim 1 further comprising a prism for deflecting the light emitted from said light source toward said working plane by approximately 90 degrees so as to be received by said spectroscope.

3. The photosensing device according to claim 2 wherein said prism comprises a first transmissible surface, a reflective surface and a second transmissible surface, wherein the light emitted from said light source penetrates through said first transmissible surface to said reflective surface and is reflected by said reflective surface so as to be deflected by said approximately 90 degrees, and the deflected light penetrates through said second transmissible surface.

4. A pointing signal generation device using said photosensing device according to claim 1.
